(19) United States
(12) Patent Application Publication
(10) Pub. No.: US 2008/0226133 A1
(43) Pub. Date: Sep. 18, 2008

(54) Use of Optical Sensors for Spray Jet Diagnostics

(76) Inventors: Jean-Luc Truche, Montsegur sur Lauzon (FR); Gregor T. Overney, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/686,200

(22) Filed: Mar. 14, 2007

(51) Int. Cl. G06K 9/00

(52) U.S. Cl. 382/112

(57) ABSTRACT

An automated method of evaluating an electrospray jet includes: capturing image information about the electrospray jet, enhancing the image information to provide a clearer image when needed, comparing the captured image information, and generating a signal to indicative of the electrospray jet operation. The signal may be used to automatically adjust the electrospray.

### BACKGROUND

An electrospray element produces an electrospray jet, e.g. fine mist of ionized liquid droplets. One application for an electrospray jet is Within the ion-source chambers of mass spectrometers. The fine mist is produced at the outlet of a spray nozzle. In operation, the quality of the electrospray jet is effected by the cleanliness of the spray nozzle and the evenness of the mist generation.

An electrospray jet is often used in an environment where it is difficult for the operator to detect whether it is operating within its designed tolerance. One detection technique includes visual inspection of the electrospray jet using video imaging. This requires trained personnel and constant operator attention.

### SUMMARY

An automated method of evaluating an electrospray jet includes: capturing image information about the electro spray jet, enhancing the image information to provide a clearer image when needed, comparing the captured image information, and generating a signal to indicative of the electrospray jet operation.

The electrospray jet may be illuminated by a source to improve the contrast between the electrospray jet and the background. Sequential images are captured at user-defined intervals by an image processor. An optional lens may be used to focus the image of the electrospray jet prior to image capture. A comparator compares the sequential images and generates a signal indicative of the operation of the electrospray jet. The signal may be used as a control signal for the electrospray jet.

### BRIEF DESCRIPTION OF THE DRAWINGS

FIG. 1 illustrates a block diagram of the system.

FIG. 2 illustrates a process flowchart for the operation of the system shown in FIG. 1.

### DETAILED DESCRIPTION

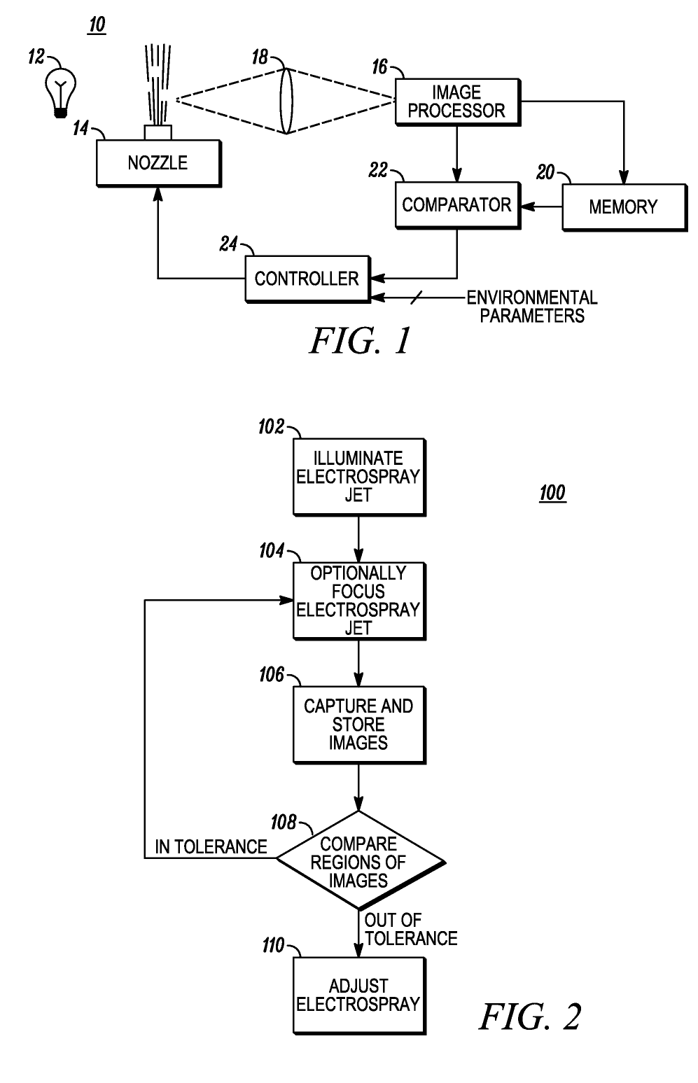

FIG. 1 is a block diagram of the automated electrospray jet evaluation system 10. A source 12 illuminates a region proximate to a spray nozzle 14. An image processor 16 captures images of the region. An optional focusing element 18 may interpose the image processor 16 and the region to focus the electrospray jet prior to image capture. The captured images may be stored in memory 20. A comparator 22 receives the captured images from memory 20 and the image processor 16 and generates a signal indicative of the electrospray jet operation. An optional controller 24 receives the signal and applies the signal to adjust the parameters of the electrospray (not shown). The parameters include electrical, pneumatic and temperature conditions.

The focusing element 18, e.g. lens, is applied to the light, which may be polarized by an optional polarizing filter (not shown).

FIG. 2 is a process flowchart 100 for the operation of the automated electrospray jet evaluation system shown in FIG. 1. In step 102, the electrospray jet is illuminated. In step 104, the image of the electrospray jet is optionally focused. In step 106, the images are captured and stored. In step 108, the identical regions of the images are compared. If the electrospray jet is operating within tolerance, return to step 104. If the electrospray jet is not in tolerance, in step 110, the controller adjusts the electrospray. Return to step 104.

A jet “image patterns” consists of shape and reflectivity characteristics of the jet. If the jet moves away from an ideal position, the intensity of light or luminosity reflected by the jet will change. When the jet moves (sputters), the geometrical shape changes. Hence changes in brightness of the recorded image and shape changes of jet can be used to determine that a not optimal spraying condition is present. This can also be a gradual change that requires the system to calculate a score, e.g. difference between brightness between newly recorded frames and the reference frame(s), to determine whether or not the jet has issues that can impact ion generation.

The image information can be integrated by the controller with the total ion current (TIC) measured by the mass spectrometer (not shown). When the brightness changes and at the same times the TIC drops significantly, it is very likely that the drop in signal is related to the quality of the spray jet and adjustments must be done to avoid continued signal drop.

The spray diagnostic may be used in any mass spectrometer system with an electrospray source, e.g. quadrupole, time-of-flight, ion trap, orbitrap, magnetic sector, and Fourier transform-ion cyclotron resonance (FT-ICR) mass analyzers or a tandem mass spectrometer system, e.g. multi-stage multipoles, orthogonal multipole MS, QTOF, Trap-TOF. Alternatively, the mass spectrometer system may include multiple sources, e.g. electrospray ionization and an additional ion source. The additional ion source may be an atmospheric pressure chemical ionization (APCI) or atmospheric pressure photoionization (APPI) source.

We claim:

1. A method of evaluating an electrospray jet comprising:
capturing and storing images of the electrospray jet;
comparing identical regions of the images; and
generating a signal indicative of the operation of the electrospray jet.

2. A method of evaluating an electrospray jet, as in claim 1, wherein an ion source within a mass spectrometer system contains the electrospray jet.

3. A method of evaluating an electrospray jet, as in claim 2, the mass spectrometer system further comprising an additional source for creating ions.

4. A method of evaluating an electrospray jet, as in claim 2, wherein the additional source is selected from a group including atmospheric pressure chemical ionization and atmospheric pressure photoionization sources.

5. A method of evaluating an electrospray jet, as in claim 2, wherein the mass spectrometer system is selected from a group including quadrupole, time-of-flight, ion trap, orbitrap, magnetic sector, and Fourier transform-ion cyclotron resonance (FT-ICR) mass analyzers.

6. A method of evaluating an electrospray jet, as in claim 2, wherein the mass spectrometer system is a tandem mass spectrometer system that is selected from a group including multi-stage multipoles, orthogonal multipole MS, QTOF, Trap-TOF.

7. A method of evaluating an electrospray jet as in claim 2, including illuminating the electrospray jet prior to capturing and storing images.

8. A method of evaluating an electrospray jet as in claim 2, including focusing the images of the electrospray jet prior to capturing and storing images.

9. A method of evaluating an electrospray jet as in claim 2, including adjusting the electrospray jet in response to the signal.

10. A method of evaluating an electrospray jet, as in claim 2 including measuring the luminosity of the images.

11. A system for evaluating an electrospray jet comprising:
an image processor positioned proximate to the electrospray jet;
memory connected to the image processor;
a comparator, connected to the memory and the image processor, generating a signal indicative of the operation of the electrospray jet; and
a controller responding to the signal.

12. A system for evaluating an electrospray jet, as in claim 11, comprising a mass spectrometer including an ion source containing the electrospray jet.

13. A system for evaluating an electrospray jet, as in claim 12, the mass spectrometer system further comprising a second ion source.

14. A system for evaluating an electrospray jet, as in claim 12, wherein the second ion source is selected from a group including APCI and APPI sources.

15. A system for evaluating an electrospray jet, as in claim 12, wherein the mass spectrometer system is selected from a group including quadrupole, time-of-flight, ion trap, orbitrap, magnetic sector, and Fourier transform-ion cyclotron resonance (FT-ICR) mass analyzers.

16. A system for evaluating an electrospray jet, as in claim 12, where in the mass spectrometer system is a tandem mass spectrometer system that is selected from a group including multi-stage multipoles, orthogonal multipole MS, QTOF, Trap-TOF.

17. A system for evaluating an electrospray jet as in claim 11 including a source illuminating the electrospray jet.

18. A system for evaluating an electrospray jet as in claim 11 including a focusing element interposing the electrospray jet and the image processor.

19. A system for evaluating an electrospray jet as in claim 18, wherein the focusing element is a lens.
